(19) United States
(12) Patent Application Publication
(10) Pub. No.: US 2020/0357122 A1
(43) Pub. Date: Nov. 12, 2020

(54) DATA ANALYSIS DEVICE AND DATA ANALYSIS SYSTEM

(71) Applicant: SHIMADZU CORPORATION, Kyoto-shi, Kyoto (JP)

(72) Inventor: Shinichi YAMAGUCHI, Kyoto-shi, Kyoto (JP)

(73) Assignee: SHIMADZU CORPORATION, Kyoto-shi, Kyoto (JP)

(21) Appl. No.: 16/961,861

(22) PCT Filed: Mar. 30, 2018
(86) PCT No.: PCT/JP2018/013593

§ 371 Date: Jul. 13, 2020

(51) Int. Cl. G06T 7/11; G06T 11/20

(52) U.S. Cl. CPC G06T 7/11; G06T 2207/10056; G06T 11/203

(57) ABSTRACT

An image creation unit (46) creates a reference image such as a stained image on the basis of data read from a reference image data storage section (44), for example, and an image sending unit (40) sends the image to a sample provider terminal (7). A sample provider checks the image using commonly used image editing software, and adds, to the image, a frame representing an ROI required for a detailed analysis. In an imaging mass spectrometer (1), an image input unit (41) receives the image to which information on the ROI has been added, and a region information extraction unit (42) extracts the ROI and stores region information on the ROI in a storage section (43). The image creation unit (46) sets, on any MS image, the ROI on the basis of the region information stored in the storage section (43), and a display processing unit (47) displays the ROI on a screen of a display unit (6). In this manner, the ROI set by the sample provider in a remote location is applied to any image, thereby enabling the image display and detailed analysis of the ROI portion.

### TECHNICAL FIELD

The present invention relates to a data analysis device and a data analysis system for analyzing data acquired through measurement or observation on a sample or specimen, and more specifically, to a data analysis device and a data analysis system suitable for analyzing data representing a two-dimensional intensity distribution of a measurement region on the sample acquired by a mass spectrometry imaging method, a microscopic infrared imaging method, or the like. Note that the “data analysis system” refers to a system including the “data analysis device” and a terminal device such as a computer which is separate from the “data analysis device” and is usually located at a considerably distant place.

### BACKGROUND ART

Various spectrometers are known that perform predetermined measurement or analysis on a sample or specimen and collect data representing a two-dimensional distribution of a predetermined physical quantity of the sample.

For example, an imaging mass spectrometer disclosed in Non Patent Literature 1 or the like is capable of measuring a two-dimensional intensity distribution of ions having specific mass-to-charge ratios m/z on a surface of a sample such as a slice of biological tissue while observing the morphology of the same surface of the sample under an optical microscope. Further, a device capable of creating an image by a microscopic infrared imaging method and a device capable of creating an image by a microscopic laser Raman spectroscopic imaging method are also known.

A description will be given below mainly of an imaging mass spectrometer using the mass spectrometry imaging method.

In such an imaging mass spectrometer, mass spectrum data over a predetermined range of mass-to-charge ratios can be acquired for each of a large number of micro regions in a two-dimensional measurement area on a sample, and an MS image representing a two-dimensional intensity distribution of ions having specific mass-to-charge ratios is created on the basis of the data. For example, observation of an MS image of ions derived from a compound that characteristically appears for a specific disease such as cancer makes it possible to grasp the extent of the disease. Accordingly, in recent years, studies, using imaging mass spectrometers, on pharmacokinetic analysis of, for example, slices of biological tissue, and analysis of differences in compound distribution between organs or of differences in compound distribution between a pathological site such as cancer and a normal site have been actively conducted.

In such an analysis, in general, a user sets one or a plurality of regions of interest (ROIs) on an MS image, and a comparative analysis, difference analysis, or the like is performed on the plurality of regions of interest or the same region of interest on different samples (see Patent Literature 1 or the like). However, it is often not possible to clearly observe an internal structure of a biological tissue with the MS image. In order to accurately set the ROI, therefore, an image such as an optical microscopic image, a stained sample image, or a fluorescence microscopic image with which the internal structure of the biological tissue can be clearly observed (hereinafter, such an image is collectively referred to as a “reference image”) is often used instead of the MS image. Further, the ROI may be set using a superposed image obtained by superposing a reference image on an MS image reflecting the distribution of a target compound.

It is important to set an appropriate ROI for appropriate and accurate analysis in mass spectrometry imaging. Setting an appropriate ROI is essential work, especially for finding a sign of disease in an early stage. However, in conventional devices, such work has the following problem.

For example, when a sample is a slice of human cancer tissue, the sample provider is usually a hospital doctor or researcher. On the other hand, the operation of measuring a sample with an imaging mass spectrometer is often performed by an analysis company that specializes in such an analysis, and in that case, the measurement is made by an analysis operator of the analysis company. In such a case, though the sample provider has detailed knowledge about the sample, the analysis operator has little detailed knowledge about the sample. In that case, the sample provider, rather than the analysis operator, can set an appropriate RO. However, in general, a computer capable of setting an ROI is located near the imaging mass spectrometer to be controlled, that is, in the analysis company, for the convenience of the measurement operation. Therefore, it is necessary for the sample provider to visit the analysis company and instruct the analysis operator to set the ROI. Such work requires time and effort, and not only lowers the work efficiency, but also increases the analysis cost.

One method to avoid such a problem is to place the computer in a hospital to which the sample provider belongs and to connect the computer to a computer placed in the analysis company over a computer network. By setting the computer placed in the hospital to have the same work environment as that of the computer placed in the analysis company, the sample provider can set the ROI using a nearby computer. However, it requires considerable time and effort to provide the computer placed in the hospital with the same work environment as that of the computer placed in the analysis company.

Such a problem is not limited to the imaging mass spectrometer, but is common to all devices capable of performing measurement by the above-described microscopic infrared imaging method, microscopic laser Raman spectroscopic imaging method, or the like, and image creation.

### CITATION LIST

### Patent Literature

Patent Literature 1: WO 2015/181893 A

### Non Patent Literature

Non Patent Literature 1: “iMScope TRIO Imaging Mass Microscope”, Shimadzu Corporation, [online], [Searched on Mar. 28, 2018], Internet <URL: http://www.an.shimadzu.co.jp/bio/imscope/>

### SUMMARY OF INVENTION

### Technical Problem

The present invention has been developed to solve the previously described problem. Its primary objective is to provide a data analysis device and a data analysis system capable of performing data analysis on the basis of ROI information that is simply and appropriately set by a sample provider without human movement or troublesome preparation of a computer environment.

### Solution to Problem

A data analysis device of a first aspect of the present invention made in order to solve the above problems is configured to analyze components contained in a sample using data representing one or a plurality of signal values at each micro region in a two-dimensional area on the sample, the data being acquired by one or a plurality of predetermined measurement methods or observation methods from the two-dimensional area, the data analysis device including

a) an image creation unit configured to create, on the basis of the data, an image for setting a region of interest on the sample where a detailed analysis is performed,

b) a region-of-interest extraction unit configured to identify information on the region of interest added, in a graphical form, to a whole or part of the image created by the image creation unit, to acquire region information representing a position of the region of interest, and to store the region information in a storage section, and

c) a region-of-interest setting unit configured to set a region of interest on another image of a same sample using the information on the region of interest stored in the storage section by the region-of-interest extraction unit.

A data analysis system of a first aspect according to the present invention includes the data analysis device of the first aspect, and a terminal device where image manipulation software is installed, the image manipulation software being capable of adding a line drawing to an existing image. In the terminal device, an image created by the image creation unit of the data analysis device is read, and a line drawing representing a region of interest is added to the image with a function of the image manipulation software, and, in the data analysis device, the image to which the line drawing has been added is read, and the region-of-interest extraction unit identifies the line drawing to acquire region information representing a position of the region of interest.

Note that image data may be exchanged between the data analysis device and the terminal device over a storage medium, or alternatively and preferably, over a communication network such as the Internet. That is, the data analysis system of the first aspect of the present invention may include a communication network interconnecting the data analysis device and the terminal device, the image being sent and received over the communication network.

In the data analysis device and the data analysis system according to the present invention, the above-described measurement method and observation method may be any of various kinds of measurements and analyses such as mass spectrometry imaging measurement, Raman spectroscopy measurement, fluorescence measurement, emission-intensity or absorption measurement of electromagnetic waves having various wavelengths (terahertz region, near or far infrared region, visible region, ultraviolet region, X-ray region, etc.), positron emission tomography (PET) measurement, magnetic resonance imaging (MRI) measurement, electron spin resonance (ESR) measurement, computed tomography (CT) measurement, surface analysis using electron probe microanalyzer (EPMA), and observation with an electron microscope, an optical microscope, a phase contrast microscope, or a digital holographic microscope.

In the case of processing data acquired by an imaging mass spectrometer, for example, the data include mass spectrum data at each micro region in a two-dimensional area, and optical microscopic image data and fluorescence microscopic image data on the same area. Upon receiving an instruction from a user (analysis operator), the image creation unit creates, on the basis of such data, an appropriate MS image, an optical microscopic image, or a superposed image of the MS image and the optical microscopic image used for setting the region of interest. For example, the sample provider who has received the image over the communication network or storage medium checks the image with a nearby terminal device (computer) and adds one or a plurality of frames representing the region of interest. Note that no special image manipulation software is required for such work, and any commercially available image manipulation software (or provided as free software) may be used.

As described above, the image to which the information on the frame indicating the region of interest or the like has been added is transferred from the terminal device to the data analysis device over the communication network or storage medium. The region-of-interest extraction unit reads the image, identifies the information thus added, and acquires, for example, position information on a region enclosed by the frame indicating the region of interest as region information representing the position of the region of interest. Then, the region information is stored in the storage section with the region information associated with the image, sample identification information, or the like. The region-of-interest setting unit sets a region of interest on another MS image of the same sample using the position information on the region of interest stored in the storage section. As a result, the region of interest defined by the sample provider or the like with the terminal device is set on any MS image of the same sample. Note that images exchanged over the communication network or the storage medium may have commonly used image file formats.

According to the data analysis device and the data analysis system of the first aspect, the data analysis device has a function of identifying the information on the region of interest added to the image and acquiring the region information representing the position of the region of interest, or alternatively, a structure where the terminal device has the function, and the region information rather than the image itself is transferred from the terminal device to the data analysis device may be employed.

That is, a data analysis system of a second aspect according to the present invention includes a data analysis device configured to analyze components contained in a sample using data representing one or a plurality of signal values at each micro region in a two-dimensional area on the sample, the data being acquired by one or a plurality of predetermined measurement methods or observation methods from the two-dimensional area, and a terminal device including a display unit and an input unit. The data analysis device includes an image creation unit configured to create, on the basis of the data, an image used for setting a region of interest on the sample where a detailed analysis is performed, and a region-of-interest setting unit configured to set, upon receiving information on the region of interest acquired by a region-of-interest extraction unit of the terminal device, a region of interest on another image of a same sample using the information on the region of interest. The terminal device includes an image manipulation unit configured to display, upon receiving the image created by the image creation unit of the data analysis device, the image on a screen of the display unit and add, in response to an input operation performed by a user on the input unit, a line drawing representing the region of interest to the image displayed, and the region-of-interest extraction unit configured to identify the line drawing representing the region of interest added to the image by the image manipulation unit to acquire region information representing a position of the region of interest.

As in the data analysis system of the first aspect, in the data analysis system of the second aspect, data may be exchanged between the data analysis device and the terminal device over a storage medium, or alternatively and preferably, over a communication network such as the Internet. That is, the data analysis system of the second aspect of the present invention may include a communication network interconnecting the data analysis device and the terminal device, the image or the region information being sent and received over the communication network.

In the data analysis system of the second aspect, it is necessary to install a program for executing the function of the region-of-interest extraction unit in addition to commonly used image manipulation software in a computer serving as the terminal device, but when the program is single-function software only for the function, installation and environment settings are simple, and operation is also simple.

### Advantageous Effects of Invention

The data analysis device and the data analysis system according to the present invention are capable of performing data analysis on the basis of the ROI information simply and appropriately set by a person in charge having detailed knowledge about the sample such as the sample provider without human movement or troublesome preparation of a computer environment. This in turn allows for appropriate and accurate analysis based on accurate ROI information.

### BRIEF DESCRIPTION OF DRAWINGS

FIG. 1 is a schematic structure diagram of an imaging mass spectrometry system corresponding to one embodiment of a data analysis system according to the present invention.

FIGS. 2A-2C are reference diagrams for describing a flow of ROI setting work for data analysis in the imaging mass spectrometry system of the present embodiment.

FIG. 3 is a schematic structure diagram of an imaging mass spectrometry system corresponding to another embodiment of the data analysis system according to the present invention.

### DESCRIPTION OF EMBODIMENTS

A description will be given below, with reference to the accompanying drawings, of an imaging mass spectrometry system corresponding to one embodiment of a data analysis system according to the present invention.

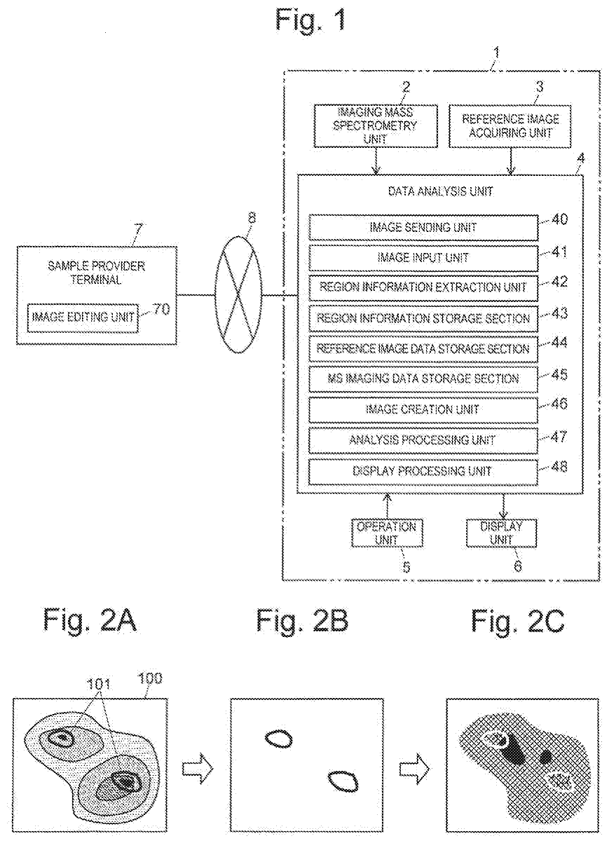

FIG. 1 is a schematic structure diagram of the imaging mass spectrometry system according to the present embodiment.

The imaging mass spectrometry system of the present embodiment has a structure where an imaging mass spectrometer 1 and a sample provider terminal 7 are interconnected over a communication network 8 such as the Internet. The imaging mass spectrometer 1 includes an imaging mass spectrometry unit 2, a reference image acquiring unit 3, a data analysis unit 4, an operation unit 5, and a display unit 6.

The sample provider terminal 7 is a commonly used personal computer, and includes an image editing unit 70 whose functions are implemented via commonly used image editing software.

The imaging mass spectrometry unit 2 includes, for example, a matrix-assisted laser desorption ionization ion trap time-of-flight mass spectrometer and is configured to perform mass spectrometry on a large number of measurement points (micro regions) in a two-dimensional measurement area on a sample such as a slice of biological tissue to acquire mass spectrum data for each of the measurement points. The reference image acquiring unit 3 is an optical microscope, a fluorescence microscope, a phase contrast microscope, or the like and is configured to acquire a reference image of the sample such as an optical microscopic image, a stained image, a fluorescent image, or a phase contrast microscopic image.

The data analysis unit 4 is configured to perform predetermined processing upon receiving the mass spectrum data on each of the measurement points collected by the imaging mass spectrometry unit 2 and the reference image data acquired on the basis of an image captured by the reference image acquiring unit 3, and includes, as functional blocks, an image sending unit 40, an image input unit 41, a region information extraction unit 42, a region information storage section 43, a reference image data storage section 44, an MS imaging data storage section 45, an image creation unit 46, an analysis processing unit 47, a display processing unit 48, and the like.

In general, the data analysis unit 4 is essentially a personal computer (or a higher-performance workstation) and is configured to cause dedicated software installed in the computer to run on the computer to enable the function of each of the above blocks. In such a structure, the operation unit 5 is a pointing device such as a keyboard or a mouse, and the display unit 6 is a display monitor.

In the imaging mass spectrometer 1, when an analysis operator sets a sample such as a slice of mouse liver at a predetermined position and designates a measurement region that is either a whole of the sample or a part of the sample using the operation unit 5, the imaging mass spectrometry unit 2 performs mass spectrometry on each of a large number of measurement points in the measurement region to acquire mass spectrum data over a predetermined range of mass-to-charge ratios. As a result, a set of pieces of mass spectrum data corresponding to the number of measurement points in the measurement region (hereinafter, referred to as “MS imaging data”) is acquired, and the data is input to the data analysis unit 4 and stored in the MS imaging data storage section 45. On the other hand, the reference image acquiring unit 3 acquires, for example, a stained image of the same sample (or another sample slice in close proximity to the sample slice of mouse liver). Image data constituting the reference image acquired by the reference image acquiring unit 3 is stored in the reference image data storage section 44.

A description will be given below, with reference to FIGS. 2A-2C in addition to FIG. 1, of distinctive processing to be performed by the data analysis unit 4 with the MS imaging data stored in the MS imaging data storage section 45 and the reference image data stored in the reference image data storage section 44 as described above. Note that the analysis operator is in a place where the analysis operator can operate the imaging mass spectrometer 1, and the sample provider is in a place where the sample provider can operate the sample provider terminal 7.

FIGS. 2A-2C are reference diagrams for describing a flow of ROT setting work for data analysis in the imaging mass spectrometry system of the present embodiment.

When the analysis operator performs a predetermined operation on the operation unit 5, the image creation unit 46 creates, in response to the operation, an MS image on the basis of data read from the MS imaging data storage section 45, a reference image on the basis of the reference image data read from the reference image data storage section 44, or a superposed image resulting from superposing an appropriate MS image on a corresponding reference image. The image thus created corresponds to an image on which information required for the sample provider to set the ROT appears, for example, an image on which a structure of biological tissue clearly appears. The image sending unit 40 sends the created image to the sample provider terminal 7 as a file in a standard format such as JPEG, GIF, or PDF. The method for sending the file is not limited to a specific method, and, for example, the file may be attached to an e-mail, or a cloud service capable of sharing the file may be used.

The sample provider uses the image editing unit 70 in the sample provider terminal 7 to open the file received and check the image. Then, one or a plurality of areas on the image considered necessary to be analyzed in detail is set as the ROT. Specifically, for example, an indication line enclosing any section on the image is entered as an RO frame. The method for setting the ROT may be any method as long as the method is pre-determined.

FIG. 2A shows an example where two frames 101 each indicating the ROT are set on a displayed image 101. Herein, the frame 101 indicating the ROI has any shape.

The sample provider sends back, to the imaging mass spectrometer 1, an image file where the ROI is set as shown in FIG. 2A. In the imaging mass spectrometer 1, the image input unit 41 receives the file thus sent. Then, the region information extraction unit 42 identifies a line drawing added to the original image on the image formed from the file thus received and acquires region information representing the region enclosed by the line. FIG. 2B shows an example where the line drawing added to the image shown in FIG. 2A, that is, the frame indicating the ROI is extracted. The region information is, for example, information representing position coordinates over the image, or relative position information on a specific object image over the image.

In general, if the information representing the ROI is simply added to the image sent from the imaging mass spectrometer 1, the position information on the image does not change, so that this position information can be used as it is as the region information. On the other hand, if the sample provider is permitted to trim, rotate, or shift the image received, differences in position may arise between the image containing the ROI information sent back to the imaging mass spectrometer 1 and the original image. Therefore, in such a case, it is preferable that conversion information on the position information between the two images be obtained by, for example, identifying the same object image in the images, and the position information on the frame indicating the ROI in the received image be replaced with the position information on the original image.

The region information extraction unit 42 stores the region information thus obtained in the region information storage section 43 with the region information associated with, for example, information for identifying an image, a sample, or the like. For example, region information corresponding to ROIs set by the sample provider for various samples may be stored with the region information associated with sample identification information.

Subsequently, when the analysis operator performs a predetermined operation on the operation unit 5, the image creation unit 46 creates the MS image on the basis of the data read from the MS imaging data storage section 45, the reference image on the basis of the reference image data read from the reference image data storage section 44, or the superposed image resulting from superposing an appropriate MS image on a corresponding reference image, and superposes, on the image thus created, graphics representing the ROT based on the region information read from the region information storage section 43. The display processing unit 48 displays this image on a screen of the display unit 6. This causes the image on which the ROT designated by the sample provider is set to be displayed on the MS image of the same sample at any mass-to-charge ratio, for example. FIG. 2C shows an example where the ROT information extracted as shown in FIG. 2B is displayed on top of an image different from the image shown in FIG. 2A.

The analysis processing unit 47 performs difference analysis or the like on an area in any image where the ROT is set. That is, analysis and display in accordance with the ROT information set by the sample provider using the sample provider terminal 7 are performed in the imaging mass spectrometer 1.

In the imaging mass spectrometry system of the above embodiment, the sample provider terminal 7 is a computer having only commonly used functions, but the sample provider terminal 7 may have some of the functions implemented in the imaging mass spectrometer 1.

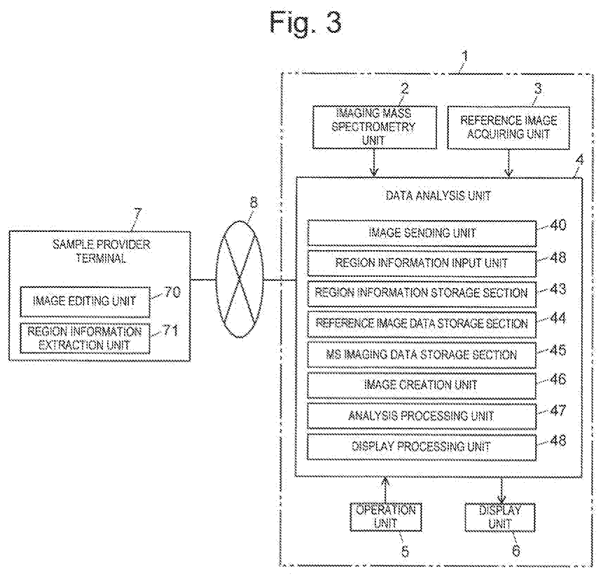

FIG. 3 is a schematic structure diagram of an imaging mass spectrometry system corresponding to another embodiment of the data analysis system according to the present invention. In this embodiment, the function of the region information extraction unit 42 provided in the imaging mass spectrometer 1 of the imaging mass spectrometry system of the above embodiment is implemented in a region information extraction unit 71 of the sample provider terminal 7.

This data analysis system is the same in basic operation to the system of the above embodiment, but since the sample provider terminal 7 includes the region information extraction unit 71, the extraction of region information from the image to which the sample provider has added the ROI information is performed in the sample provider terminal 7, the region information thus extracted rather than image data is sent from the sample provider terminal 7 to the imaging mass spectrometer 1 and then stored in the region information storage section 43. This makes it possible to reduce the amount of data sent from the sample provider terminal 7 to the imaging mass spectrometer 1 as compared to the above embodiment.

Note that the above embodiments are examples where the present invention is applied to an imaging mass spectrometry system, but it is obvious that the present invention is applicable to a device or a system that analyzes data acquired by various measurement methods or observation methods other than the mass spectrometry imaging method.

Further, the above embodiments are examples of the present invention, and it is needless to say that any change, modification, or addition within the spirit of the present invention falls within the scope of the claims of the present application.

### REFERENCE SIGNS LIST

1 . . . Imaging Mass Spectrometer
2 . . . Imaging Mass Spectrometry Unit
3 . . . Reference Image Acquiring Unit
4 . . . Data Analysis Unit
40 . . . Image Sending Unit
41 . . . Image Input Unit
42 . . . Region Information Extraction Unit
43 . . . Region Information Storage Section
44 . . . Reference Image Data Storage Section
45 . . . MS Imaging Data Storage Section
46 . . . Image Creation Unit
47 . . . Analysis Processing Unit
48 . . . Display Processing Unit
5 . . . Operation Unit
6 . . . Display Unit
7 . . . Sample Provider Terminal
70 . . . Image Editing Unit
71 . . . Region Information Extraction Unit

1. A data analysis device configured to analyze components contained in a sample using data representing one or a plurality of signal values at each micro region in a two-dimensional area on the sample, the data being acquired by one or a plurality of predetermined measurement methods or observation methods from the two-dimensional area, the data analysis device comprising:
a) an image creation unit configured to create, on a basis of the data, an image for setting a region of interest on the sample where a detailed analysis is performed;
b) a region-of-interest extraction unit configured to identify information on the region of interest added, in a graphical form, to a whole or part of the image created by the image creation unit, to acquire region information representing a position of the region of interest, and to store the region information in a storage section; and
c) a region-of-interest setting unit configured to set a region of interest on another image of a same sample using the information on the region of interest stored in the storage section by the region-of-interest extraction unit.

2. A data analysis system comprising:
the data analysis device according to claim 1; and
a terminal device where image manipulation software is installed, the manipulation software being capable of adding a line drawing to an existing image, wherein
in the terminal device, an image created by the image creation unit of the data analysis device is read, and a line drawing representing a region of interest is added to the image with a function of the image manipulation software, and
in the data analysis device, the image to which the line drawing has been added is read, and the region-of-interest extraction unit identifies the line drawing to acquire region information representing a position of the region of interest.

3. The data analysis system according to claim 2, further comprising a communication network interconnecting the data analysis device and the terminal device, the image being sent and received over the communication network.

4. A data analysis system comprising:
a data analysis device configured to analyze components contained in a sample using data representing one or a plurality of signal values at each micro region in a two-dimensional area on the sample, the data being acquired by one or a plurality of predetermined measurement methods or observation methods from the two-dimensional area; and
a terminal device including a display unit and an input unit, wherein
the data analysis device includes
an image creation unit configured to create, on a basis of the data, an image used for setting a region of interest on the sample where a detailed analysis is performed, and
a region-of-interest setting unit configured to set, upon receiving information on the region of interest acquired by a region-of-interest extraction unit of the terminal device, a region of interest on another image of a same sample using the information on the region of interest, and
the terminal device includes
an image manipulation unit configured to display, upon receiving the image created by the image creation unit of the data analysis device, the image on a screen of the display unit and add, in response to an input operation performed by a user on the input unit, a line drawing representing the region of interest to the image displayed, and
the region-of-interest extraction unit configured to identify the line drawing representing the region of interest added to the image by the image manipulation unit to acquire region information representing a position of the region of interest.

5. The data analysis system according to claim 4, further comprising a communication network interconnecting the data analysis device and the terminal device, the image or the region information being sent and received over the communication network.
